(19) United States
(12) Patent Application Publication
(10) Pub. No.: US 2011/0225798 A1
(43) Pub. Date: Sep. 22, 2011

(54) CARRIER APPARATUS FOR DRIVE-TRAIN COMPONENT PART ASSEMBLY AND VEHICLE ASSEMBLY METHOD

(75) Inventors: Toshihisa Shimoda, Tokyo (JP); Yoshihiro Nishizawa, Tokyo (JP); Mitsuru Ichimura, Tokyo (JP)

(73) Assignee: HONDA MOTOR CO., LTD., Tokyo (JP)

(21) Appl. No.: 13/122,506

(22) PCT Filed: Sep. 11, 2009
(86) PCT No.: PCT/JP2009/066320

§ 371 Date: Jun. 14, 2011

(30) Foreign Application Priority Data
Oct. 2, 2008 (JP) 2008-257897

(51) Int. Cl. B62D 65/18; B62D 65/10

(52) U.S. Cl. 29/430; 198/339.1

(57) ABSTRACT

Front retaining frame (15) retains a front drive-train component part assembly (35) having front suspensions (38) combined with an engine (36) in advance, and a rear retaining frame (18) retains a rear drive-train component part assembly (47) having rear suspensions (51) combined with a rear wheel axle (49) in advance. Elevated transport path (11, 14, 17) transports the front and rear retaining frames (15, 18), having the front and rear drive-train component part assemblies retained thereby in a hung-down state, with the front and rear retaining frames detachably attached to a retaining frame positioning member. By use of the front and rear retaining frames, human operators can perform all or most of necessary operations in a downwardly-looking posture, which can improve a working environment.

### TECHNICAL FIELD

The present invention relates to an improvement in vehicle assembling techniques.

### BACKGROUND ART

It is known that assembling suspensions of vehicles takes a great number of steps because the suspensions of vehicles are complicated in construction and require a wheel alignment adjustment. Thus, various measures for coping with the laborious assembling operations have been proposed, one example of which is disclosed in Japanese Patent Application Laid-Open Publication No. HEI-08-099658 (JP 08-099658 A).

FIG. 13 hereof illustrates the basic principle of a conventional technique for assembling a lower section of a vehicle. In FIG. 13, a rear suspension assembly 101 is in a standby state on a pallet shifter 103 after having been transferred from a rear suspension assembly line 102 to the pallet shifter 103. Meanwhile, a vehicle body 104 is transported hung by hangers 105 as depicted by imaginary line. Once the vehicle body 104 reaches a predetermined position, the rear suspension assembly 101 is assembled to the vehicle body 104 by means of a working robot 106. According to the technique disclosed in JP 08-099658 A, the operation for assembling the rear suspension assembly 101 to the vehicle body 104, which used to be performed in the past manually by two human operators, is performed in an unmanned manner, i.e. by the working robot 106.

Then, various operations including an alignment adjustment have to be performed on the rear suspension assembly 101 assembled to the vehicle body 104. However, most of these operations are upward operations (i.e., operations that have to be performed by human operators looking upward), which require experienced human operators. Thus, there has been a need for an improvement of the working environment to allow even unexperienced human operators to appropriately perform the operations.

There has also been proposed a method for assembling a suspension assembly etc. to a vehicle body accurately and efficiently, for example, in Japanese Patent Application Laid-Open Publication No. 2007-216789 (JP 200-216789 A). More specifically, JP 2007-216789 A discloses a vehicle-body reference section setting method, according to which the suspension assembly moved up and down via a lifter can be promptly and readily assembled or mounted, by use of a positioning jig, to a body shell (or body in white) transported via an overhead conveyer.

### DISCLOSURE OF INVENTION

In view of the foregoing, it is an object of the present invention to provide a technique which can achieve an improved working environment for assembling a lower section of a vehicle.

In order to accomplish the above-mentioned object, the present invention provides an improved drive-train component part assembly carrier apparatus, which comprises: a front retaining frame for retaining a front drive-train component part assembly having a front suspension combined with an engine in advance; a rear retaining frame for retaining a rear drive-train component part assembly having a rear suspension combined with a rear wheel axle in advance; and a transport path for transporting the front retaining frame and the rear retaining frame, having the front drive-train component part assembly and the rear drive-train component part assembly retained thereby to a desired position on the transport path, with the front and rear retaining frames attachably and detachably retained by a frame positioning member transportable along the path.

The front drive-train component part assembly is transported while being kept retained by the front retaining frame, and the rear drive-train component part assembly is transported while being kept retained by the rear retaining frame. Because the front and rear retaining frames only have to retain the front and rear drive-train component part assemblies, the front and rear retaining frames can be constructed in a sufficiently small size as compared to corresponding ones of the front and rear drive-train component part assemblies. By the use of the front and rear retaining frames, human operators can readily face and access all of the surfaces, except for the upper surface, of the front and rear drive-train component part assemblies, for example, standing beside the component part assemblies. As a result, the human operators can, for example, readily assemble component parts, such as a starter motor and compressor of an air conditioner, to the front drive-train component part assembly around the engine in a comfortable operating posture, and thus, the present invention can significantly improve the working environment for the human operators.

In an embodiment, the transport path is an elevated transport path, and the front and rear drive-train component part assemblies are retained by the front and rear retaining frames, respectively, in a hung-down state from the front and rear retaining frames. Further, the front retaining frame and the rear retaining frame, having the front drive-train component part assembly and the rear drive-train component part assembly retained thereby in a hung-down state, are transported to a desired position along the transport path via the frame positioning member.

According to another aspect of the present invention, there is provided an improved vehicle assembly method, which comprises: a step of causing a front retaining frame, transported along a first sub transport path, to retain a front drive-train component part assembly having a front suspension combined with an engine in advance; a step of causing a rear retaining frame, transported along a second sub transport path, to retain a rear drive-train component part assembly having a rear suspension combined with a rear wheel axle in advance; a step of coupling together the front retaining frame and the rear retaining frame, having the front drive-train component part assembly and the rear drive-train component part assembly retained thereby, by introducing by the front and rear retaining frames onto a main transport path; a step of transferring the front drive-train component part assembly and the rear drive-train component part assembly from the front retaining frame and the rear retaining frame to front and rear receiving members, respectively, a step of causing the front receiving member and the rear receiving member, having the front drive-train component part assembly and the rear drive-train component part assembly received thereby, to face a vehicle body (vehicle body in white); and a step of mounting the front drive-train component part assembly and the rear drive-train component part assembly to the vehicle body

With the vehicle assembly method of the present invention too, the front drive-train component part assembly is transported along the first sub transport path while being kept retained by the front retaining frame, and the rear drive-train component part assembly is transported along the second sub transport path while being kept retained by the rear retaining frame. Because the front and rear retaining frames only have to retain the front and rear drive-train component part assemblies, the front and rear retaining frames can be constructed in a sufficiently small size as compared to corresponding ones of the front and rear drive-train component part assemblies. Thus, human operators can readily face and access all of the surfaces, except for the upper surface, of the front and rear drive-train component part assemblies, for example, standing beside the component part assemblies. As a result, the human operators can work in a comfortable operating posture, and thus, the present invention can significantly improve the working environment for the human operators.

In an embodiment, the first and second sub transport paths and the main transport path are each an elevated transport path, and the front and rear drive-train component part assemblies are retained by the front and rear retaining frames, respectively, in a hung-down state from the front and rear retaining frames. The front retaining frame and the rear retaining frame, having the front drive-train component part assembly and the rear drive-train component part assembly retained thereby in a hung-down state, are transported to a desired position along the main transport path.

Preferably, the vehicle assembly method of the invention further comprises a step of connecting a propeller shaft to the front drive-train component part assembly and the rear drive-train component part assembly after the step of coupling together the front retaining frame and the rear retaining frame via the transport paths. Namely, whereas the operation for connecting the propeller shaft to the front and rear drive-train component part assemblies was performed separately in the prior art techniques, such a propeller shaft connecting operation can be incorporated into a series of the aforementioned steps. Thus, the present invention can reduce a total number of necessary assembling steps.

### BRIEF DESCRIPTION OF DRAWINGS

FIG. 1 is a view showing a general layout of a carrier apparatus for a drive-train component part assembly according to an embodiment of the present invention;

FIG. 2 is a perspective view of a main carrier in the carrier apparatus;

FIGS. 3A and 3B are views showing a construction of a front retaining frame in the carrier apparatus;

FIG. 4 is a view explanatory of how operations are performed in a first sub transport path;

FIGS. 5A and 5B are perspective view of a rear retaining frame in the carrier apparatus;

FIG. 6 is a view explanatory of how operations are performed in a propeller shaft mounting zone;

FIG. 7 is a view taken in a direction 7 of FIG. 6;

FIG. 8 is a sectional view of the rear retaining frame in the carrier apparatus;

FIG. 9 is a plan view of the rear retaining frame;

FIGS. 10A and 10B are views explanatory of behavior of the rear retaining frame;

FIG. 11 is a perspective view of an assembly line for assembling the front drive-train component part assembly and rear drive-train component part assembly to a vehicle body;

FIG. 12 is a perspective view of a vehicle assembly line; and

FIG. 13 is a view explanatory of the basic principle of a conventional technique for assembling a lower section of a vehicle.

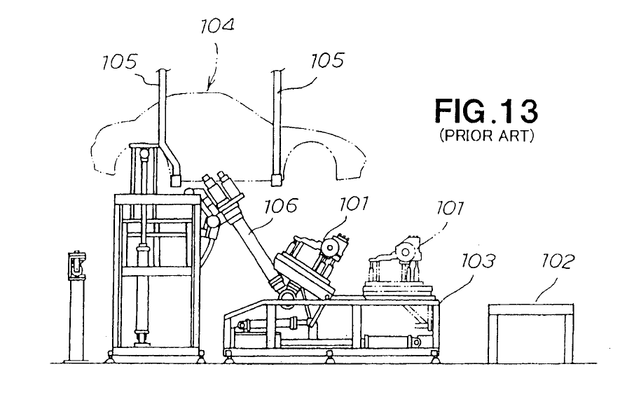

### MODES FOR CARRYING OUT THE INVENTION

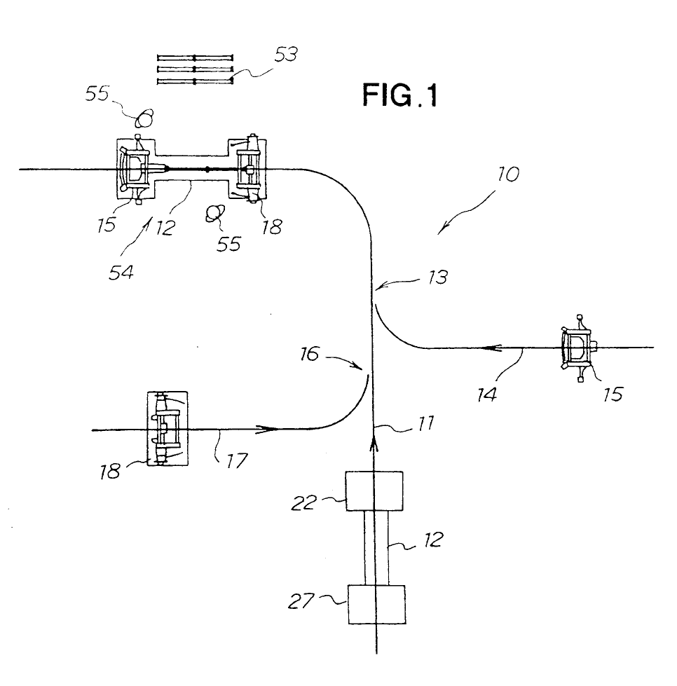

FIG. 1 is a view showing a general layout of a carrier apparatus 10 for a drive-train component part assembly (hereinafter “drive-train component part assembly carrier apparatus”) according to an embodiment of the present invention. The drive-train component part assembly carrier apparatus 10 includes: a main elevated transport path (hereinafter “main transport path”) 11; a main carrier 12 held on the main transport path 11 for movement along the main transport path 11; a first sub elevated transport path (hereinafter “first sub transport path”) 14 merging into the main transport path 11 at a first merging section 13; a front retaining frame 15 transportable along the first sub transport path 14; a second sub elevated transport path (hereinafter “second sub transport path”)17 merging into the main transport path 11 at a second merging section 16; a rear retaining frame 18 transportable along the second sub transport path 17. The main transport path 11, first sub transport path 14 and second sub transport path 17 are located at a given height from a floor surface.

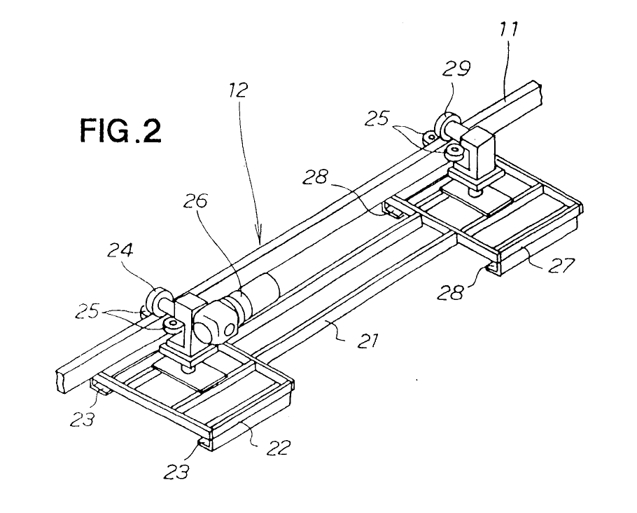

A detailed construction of the drive-train component part assembly carrier apparatus 10 is described next. FIG. 2 is a perspective view of the main carrier 12. The main carrier 12 includes: a front rectangular frame section 22 provided on a front portion of a longitudinal beam 21, extending along the main transport path 11, and having a pair of opposed accommodating channels 23 formed in opposite sides thereof, each of the accommodating channels having a laterally-facing U sectional shape; a driving roller 24 rotatably mounted on the front rectangular frame section 22 in contact with the main transport path 11; a drive source (electric motor) 26 for driving the driving roller 24; and free-rotation rollers 25 provided in contact with opposite sides of the main transport path 11. The main carrier 12 also includes: a rear rectangular frame section 27 provided on a rear portion of the longitudinal beam 21 and having a pair of opposed accommodating channels formed in opposite sides thereof, each of the accommodating channels 28 having a laterally-facing U sectional shape; a driven roller 29 rotatably mounted on the rear rectangular frame section 27 in contact with the main transport path 11 and free-rotation rollers 25 provided in contact with opposite sides of the main transport path 11.

The main carrier 12 also functions as a frame positioning member for positioning the front retaining frame 15 and rear retaining frame 18 to be later described.

Distance between the front rectangular frame section 22 and the rear rectangular frame section 27 corresponds to a distance between front and rear wheels of the vehicle to be assembled. Namely, the distance between the front rectangular frame section 22 and the rear rectangular frame section 27 is adjustable in accordance with a type of a vehicle body to be assembled. Further, the main carrier 12 can freely travel and stop along the main transport path 11 by means of the drive source 26.

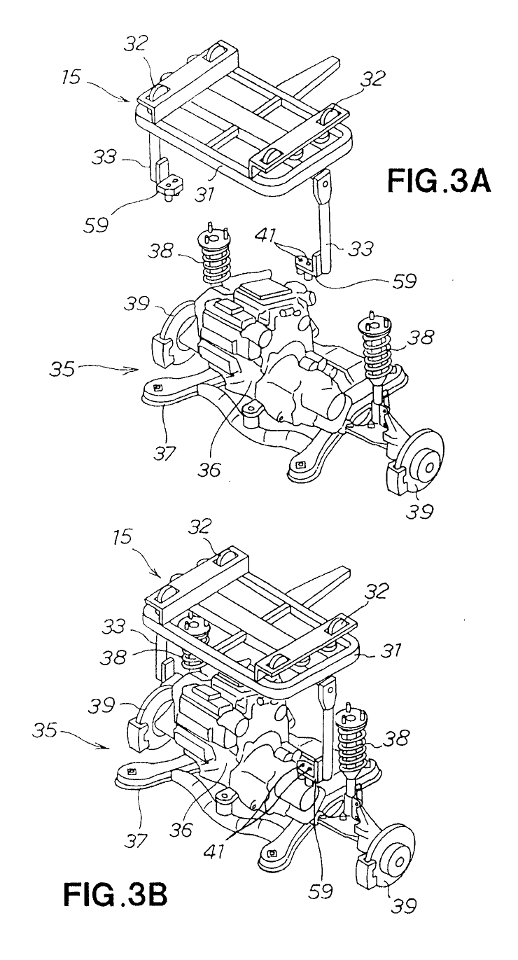

FIGS. 3A and 3B are views showing a construction of the front retaining frame 15. As shown in FIG. 3A, the front retaining frame 15 includes a frame 31 shaped to fit in, or engage with, the accommodating channels 23 of the front rectangular frame section 22 of the main carrier 12, rollers 32 for slidingly contacting the front rectangular frame section 22 of the main carrier 12, and hanger arms 33 extending downward from the frame 31. Thus, the front retaining frame 15 is detachably attachable to the main carrier 12.

Front drive-train component part assembly 35 is an assembly or combination including an engine 36, sub frame 37, front suspensions 38, brake hubs 39, etc. assembled or combined together in advance; particularly, the front suspensions 38 have been combined with the engine 36 in advance. Each reference numeral 59 depicts a jig.

As shown in FIG. 3B, the front drive-train component part assembly 35 is attached to the lower ends of the hanger arms 33 by means of the jig 59 and bolts 41, so that the front drive-train component part assembly 35 is retained by the front retaining frame 15, hung down from the front retaining frame 15.

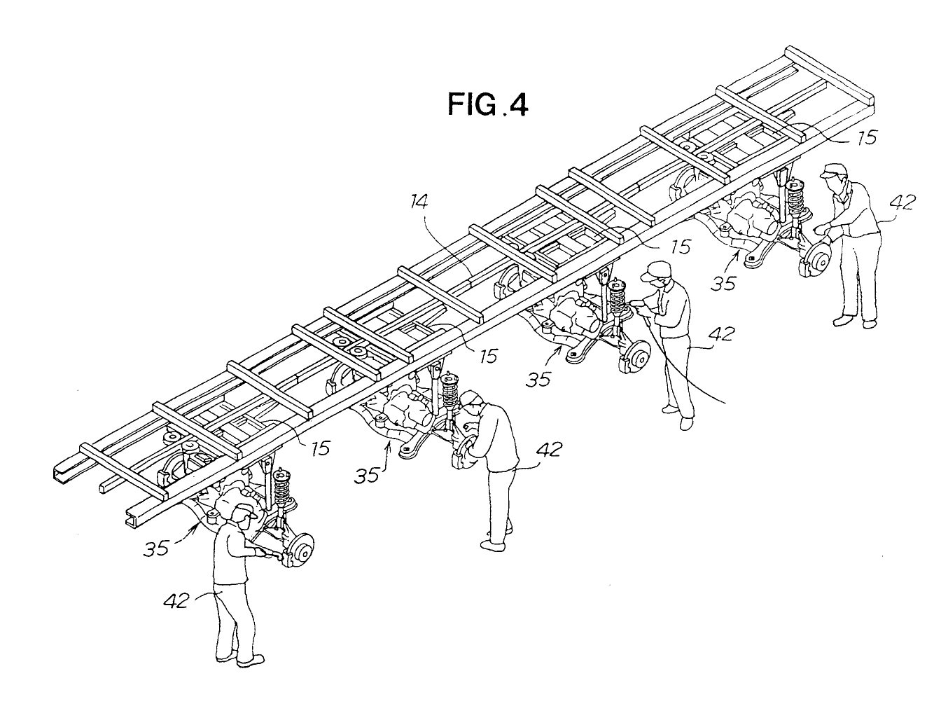

FIG. 4 is a view explanatory of how operations are performed in the above-mentioned first sub transport path 14. Human operators 42 assemble various component parts, such as a compressor of an air conditioner, starter motor and generator, to the front drive-train component part assembly 35 transported along the first sub transport path 14 via the front retaining frame 15 (i.e., while being kept retained by the frame 15 in a hung state) and performs various adjustments (including an alignment adjustment).

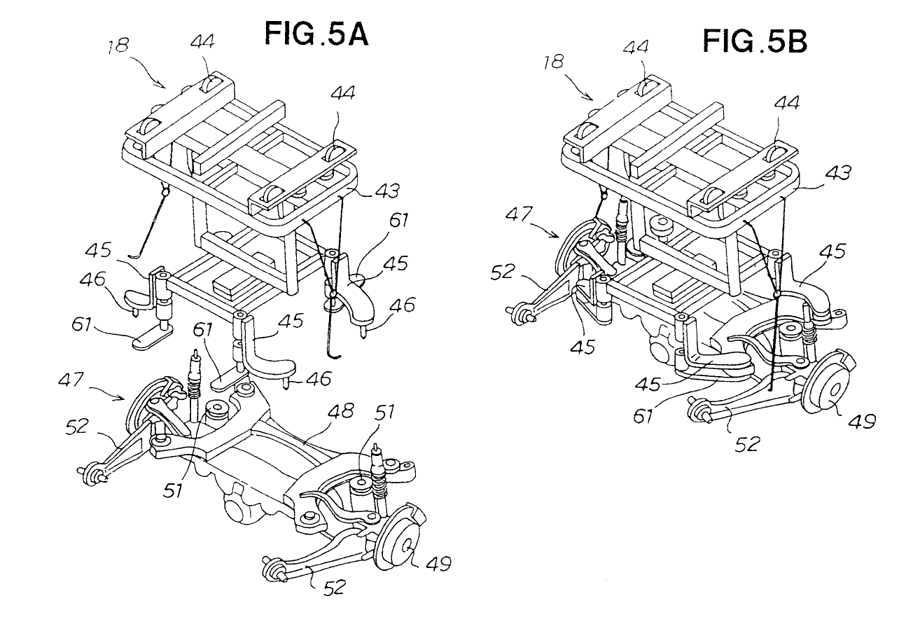

FIGS. 5A and 5B are views showing a construction of the rear retaining frame 18. As shown in FIG. 5A, the rear retaining frame 18 includes a frame 43 shaped to fit in, or engage with, the accommodating channels 28 of the rear rectangular frame section 27 of the main carrier 12, rollers 44 for slidingly contacting the rear rectangular frame section 27 of the main carrier 12, four hanger arms 45 extending downward from the frame 43, pins 46 projecting downward from the undersides of the hanger arms 45, and stoppers 61. Thus, like the front retaining frame 15, the rear retaining frame 18 is detachably attachable to the main carrier 12.

Rear drive-train component part assembly 47 has a sub frame 48, a rear wheel axle 49, rear suspensions 51, knuckles 52, etc. assembled together in advance; particularly, the rear suspensions 51 have been combined with the rear wheel axle 49 in advance.

As shown in FIG. 5B, the rear drive-train component part assembly 47 is retained on the rear retaining frame 18, hung down from the rear retaining frame 18, by being attached thereto by means of the above-mentioned pins 46. Although not described in detail, operations similar to those of FIG. 4 (i.e., operations performed on the front drive-train component part assembly 35) can be performed on the rear drive-train component part assembly 47, retained by and hung down from the rear retaining frame 18, while the rear drive-train component part assembly 47 is being transported along the second sub transport path 17.

As seen in FIG. 1, the front retaining frame 15 is introduced onto the main transport path 11 from the first sub transport path 14. Then, near the first merging section 13, the main carrier 12 is moved forward to the front retaining frame 15, so that the front retaining frame 15 is inserted into engagement with the front rectangular frame section 22 of the main carrier 12.

After that, the rear retaining frame 18 is introduced onto the main transport path 11 from the second sub transport path 17. Then, the rear retaining frame 18 is moved forward relative to the main carrier 12 on the main transport path 11, so that the rear retaining frame 18 is inserted into engagement with the rear rectangular frame section 27 of the main carrier 12.

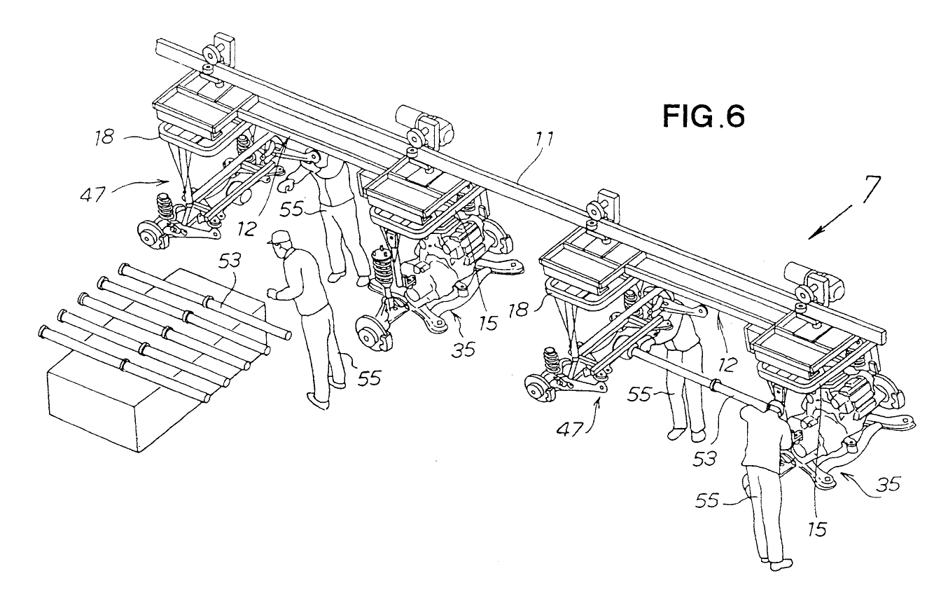

Next, a description will be given about a propeller shaft mounting zone 54. FIG. 6 is a view explanatory of how operations are performed in the propeller shaft mounting zone 54. The front drive-train component part assembly 35 and the rear drive-train component part assembly 47 are transported to the main transport path 11 while being kept retained by the main carrier 12 in the hung-down state. Then, on the basis of predetermined operating instructions, human operators 55 perform predetermined operations (that may include an alignment adjustment) on the front drive-train component part assembly 35 and the rear drive-train component part assembly 47 and connect a propeller shaft 53 to the front and rear drive-train component part assemblies 35 and 47. Support section 64 of the rear retaining frame 18 for supporting the rear drive-train component part assembly 47 is slid in the front-rear direction of the rear retaining frame 18 in accordance with the lengths of a wheelbase and the propeller shaft 53 of the vehicle body to be assembled, as will be later detailed.

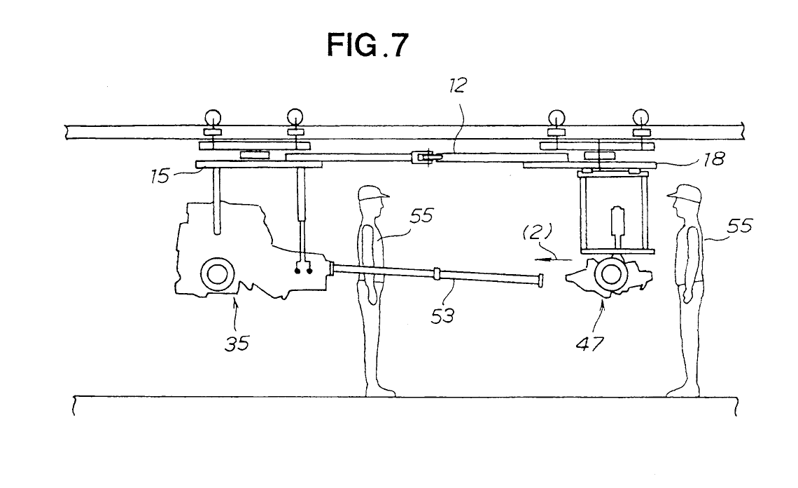

FIG. 7 is a view taken in a direction 7 of FIG. 6. The propeller shaft 53 is connected to the rear drive-train component part assembly 47 by the rear drive-train component part assembly 47 being moved forward as indicated by arrow (2). At the time of this connection operation, the human operators 55 can work standing beside the front drive-train component part assembly 35 and the rear drive-train component part assembly 47, by the front and rear retaining frames 15 and 18 having the front and rear drive-train component part assemblies 35 and 47 hung down therefrom. Generally, human operators have to take upwardly-looking, downwardly-looking and laterally-looking operating (or working) postures, of which the upwardly-looking operating posture is considered rather difficult while the downwardly-looking operating posture is considered rather easy. However, in the instant embodiment, where the front and rear drive-train component part assemblies 35 and 47 are retained hung from the front and rear retaining frames 15 and 18, all or most of the operations (including an alignment adjustment) can be performed in the downwardly-looking operating posture or laterally-looking operating posture, and thus, the working environment can be significantly improved.

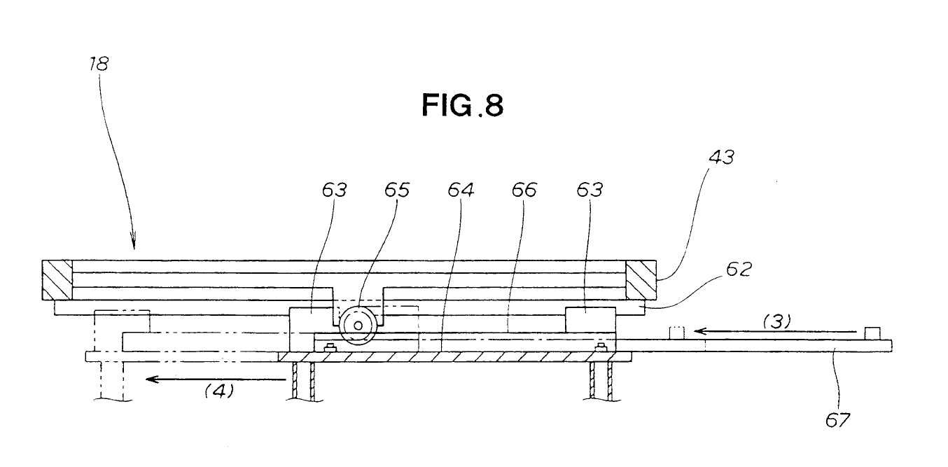

FIG. 8 is a sectional view of the rear retaining frame 18. Rail 62 is fixed to the underside of the frame 43 of the rear retaining frame 18, and sliders 63 are slidably mounted on the rail 62. The support section 64 for supporting the rear drive-train component part assembly 47 (FIG. 7) is mounted to the sliders 63. The frame 43 and the support section 64 are interconnected, by means of a pinion 65 rotatably supported on the frame 43 and a rack 66 provided on the support section 64, in such a manner that the frame 43 and the support section 64 are horizontally movable relative to each other in the transported direction of the rear retaining frame 18.

As a pusher member 67 is pushed as indicated by an arrow (3), the rack 66, sliders 63 and support section 64 are moved leftward as indicated by an arrow (4) in the figure.

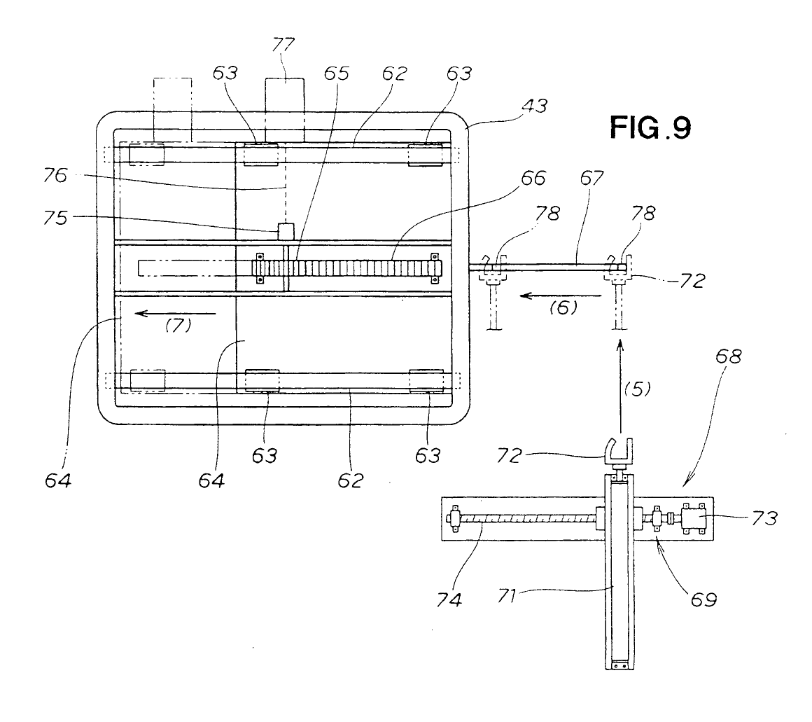

FIG. 9 is a plan view of the rear retaining frame 18. Pusher mechanism 68 is provided on a mount near the rear retaining frame 18, and this pusher mechanism 68 includes a feed section 69, a cylinder unit 71, a claw 72, a motor 73, a feed screw 74, a brake 75, a pipe 76, and an air supply unit 77.

The pinion 65 is placed in a freely rotatable state by termination of air supply from the air supply unit 77 to the brake 75. Then, the claw 72 is moved, by the cylinder unit 71, toward a projection 78 of the pusher member 67 as indicated by an arrow (5). Once the claw 72 contacts the projection 78, the claw 72 is moved by the feed section 69 as indicated by an arrow (6), and simultaneously, the support section 64 moves as indicated by an arrow (7). In this manner, the support section 64 supporting the rear drive-train component part assembly 47 can be moved to a desired position in the horizontal, transported direction of the rear retaining frame 18.

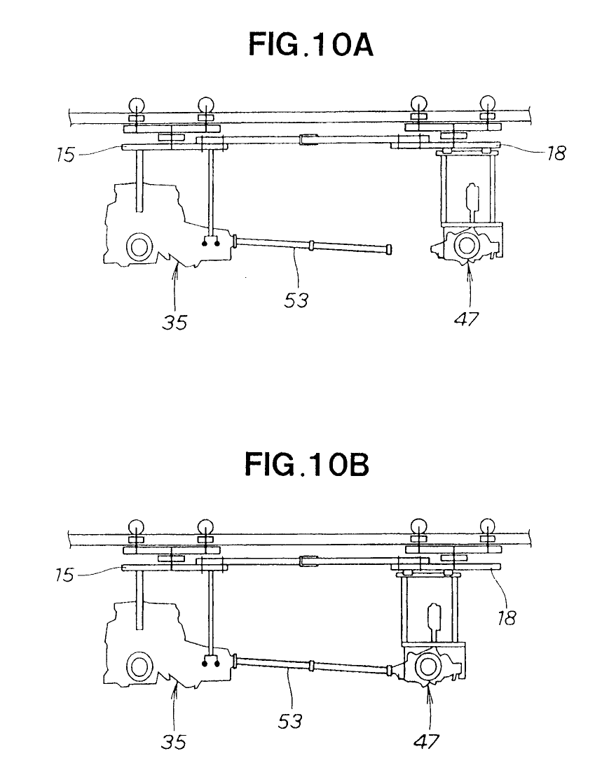

FIGS. 10A and 10B are views explanatory of behavior of the rear retaining frame 18 and more specifically how the propeller shaft 53 is connected to the rear drive-train component part assembly 47. As shown in FIG. 10A, the propeller shaft 53 having been connected to the front drive-train component part assembly 35 is caused to face the rear drive-train component part assembly 47. Then, as shown in FIG. 10B, the rear drive-train component part assembly 47 is moved toward the propeller shaft 53 by the claw 72 (FIG. 9) pushing the projection 78 (FIG. 9) of the pusher member 67, so that the propeller shaft 53 is connected to the rear drive-train component part assembly 47.

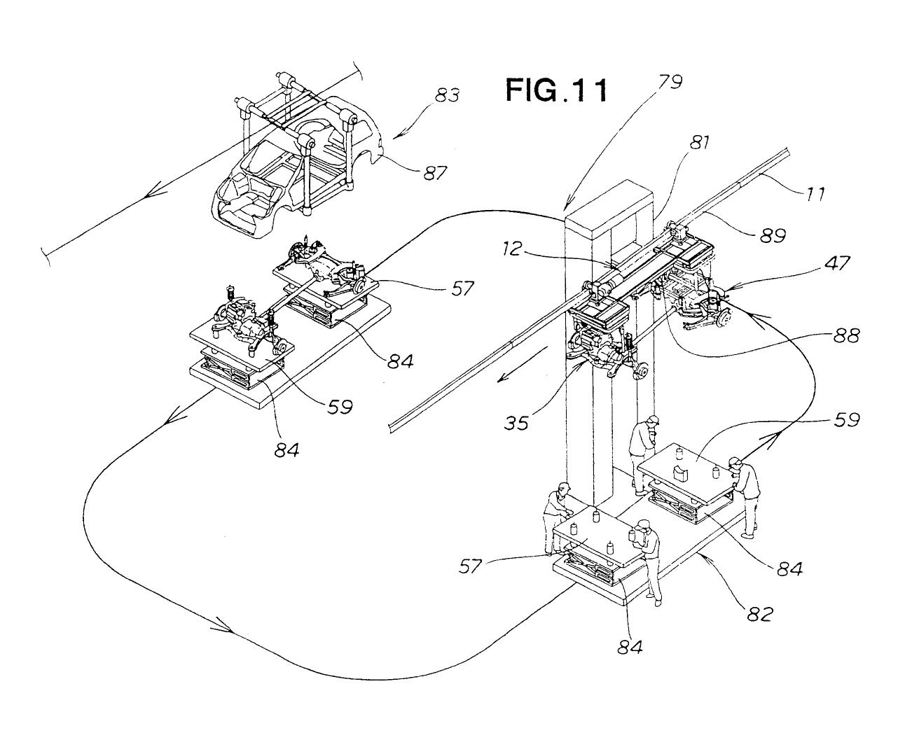

FIG. 11 is a perspective view of an assembly line 79 for assembling the front drive-train component part assembly 35 and the rear drive-train component part assembly 47 to the vehicle body. This assembly line 79 includes a drop lifter 81 and a floor conveyer 82. Reference numeral 83 indicates a vehicle body transport line, 84 a lifter, 87 the vehicle body, 88 a carrier support member, and 89 a transporting rail.

The main carrier 12, having stopped on the transporting rail 89, descends while being kept supported by the carrier support member 88 of the drop lifter 81 and is then received by, i.e. placed on, front and rear receiving members (or positioning pallets) 57 and 59. The front and rear receiving members (positioning pallets) 57 and 59 having the front drive-train component part assembly 35, propeller shaft 53 and rear drive-train component part assembly 47 placed thereon on are transported via the front conveyer 82 to the vehicle body transport line 83. Then, the front and rear receiving members (positioning pallets) 57 and 59 having the front drive-train component part assembly 35, propeller shaft 53 and rear drive-train component part assembly 47 placed thereon are lifted via the lifters 84 to face the vehicle body 87, so that the front and rear drive-train component part assemblies 35 and 36 and the propeller shaft 53 are assembled to the vehicle body 87.

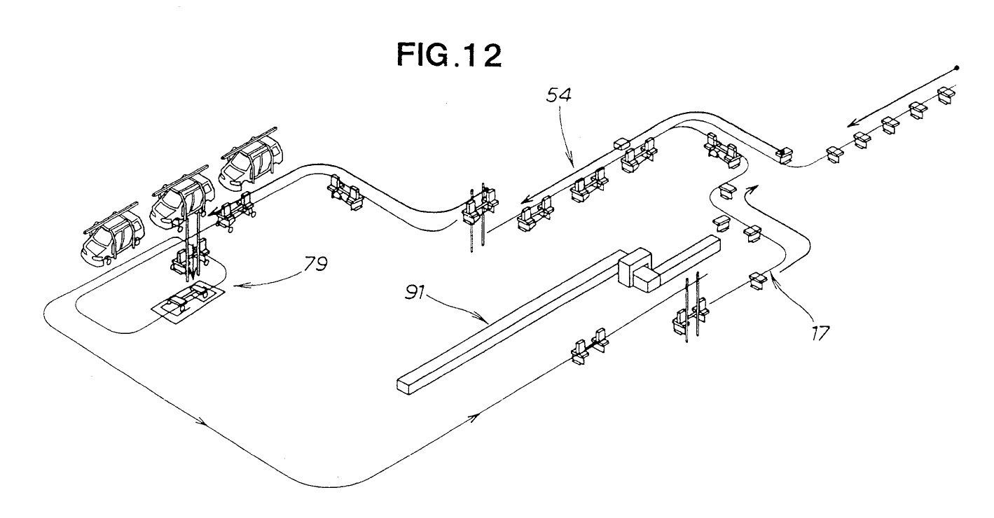

FIG. 12 is a perspective view of a vehicle assembly line. Alignment adjustment is performed on the rear drive-train component part assembly 47 in a sub line 91. Further, in the second sub transport path 17, the support section 64 of FIG. 9 is slid to a desired horizontal position through the operation described above in relation to FIG. 9.

Next, in the propeller shaft mounting zone 54, the rear drive-train component part assembly 47 is moved to the propeller shaft 53 by the claw 72 (FIG. 9) pushing the projection 78 (FIG. 9) of the pusher member 67, so that the propeller shaft 53 is connected to the rear drive-train component part assembly 47, as described above in relation to FIG. 10.

In addition, in the assembly line 79, the main carrier 12, having stopped on the transporting rail 89 as described above in relation to FIG. 11, descends while being kept supported by the carrier support member 88 of the drop lifter 81 and is then received by or placed on the front and rear receiving members (positioning pallets) 57 and 59. The front drive-train component part assembly 35, propeller shaft 53 and rear drive-train component part assembly 47 having been placed on the front and rear receiving members 57 and 59 in the aforementioned manner are transported via the front conveyer 82 to the vehicle body transport line 83. Then, the front drive-train component part assembly 35, propeller shaft 53 and rear drive-train component part assembly 47 are lifted via the lifters 84 to be assembled or mounted to the vehicle body 87.

Because the various adjustments and mounting, to the front drive-train component part assembly 35 and rear drive-train component part assembly 47, of the propeller shaft 35 have been completed prior to the mounting, to the vehicle body 87 of the component part assemblies 35 and 47 and propeller shaft 35, many of operations to be performed after the mounting, to the vehicle body, of the aforementioned components can be omitted.

In sum, according to the basic principle of the present invention, the front retaining frame 15 transported along the first sub transport path 14 is caused to retain the front drive-train component part assembly 35 having the front suspensions 38 combined with the engine 36 in advance, and the rear retaining frame 18 transported along the second sub transport path 17 is caused to retain the rear drive-train component part assembly 47 having the rear suspensions 51 combined with the rear wheel axle 49 in advance. Then, the front and rear retaining frames 15 and 18, having the front and rear drive-train component part assemblies 35 and 47 retained thereby in the hung-down state are coupled together by the front and rear retaining frames 15 and 18 being introduced onto the main transport path 11. After that, the front drive-train component part assembly 35 and the rear drive-train component part assembly 47 are transferred from the front and rear retaining frames 15 and 18 to the front and rear receiving members (positioning pallets) 57 and 59, respectively. Then, the front and rear receiving members 57 and 59 having the front drive-train component part assembly 35 and rear drive-train component part assembly 47 received thereby (placed thereon) are caused to face the vehicle body 87, so that the front and rear drive-train component part assemblies 35 and 36 are assembled or mounted to the vehicle body 87. It is preferable that the propeller shaft 53 be connected to the front drive-train component part assembly 35 and the rear drive-train component part assembly 47 after the front retaining frame 15 and the rear retaining frame 18 have been coupled together by the front and rear retaining frames 15 and 18 being introduced onto the main transport path 11.

It should be noted that the main carrier 12 may be of any desired shape and construction as long as it can appropriately retain the front and rear retaining frames 15 and 18 in the order mentioned.

### INDUSTRIAL APPLICABILITY

The present invention is well suited for application to vehicle assembly lines where drive-train component part assemblies are subjected to adjustments etc. while being transported.

1. A drive-train component part assembly carrier apparatus comprising:
a front retaining frame for retaining a front drive-train component part assembly having a front suspension combined with an engine in advance;
a rear retaining frame for retaining a rear drive-train component part assembly having a rear suspension combined with a rear wheel axle in advance; and
a transport path for transporting the front retaining frame and the rear retaining frame, having the front drive-train component part assembly and the rear drive-train component part assembly retained thereby to a desired position on the transport path, with the front and rear retaining frames attachably and detachably retained by a frame positioning member mounted on the transport path for movement along the transport path.

2. The drive-train component part assembly carrier apparatus of claim 1, wherein the transport path is an elevated transport path, and the front and rear drive-train component part assemblies are retained by the front and rear retaining frames, respectively, in a hung-down state from the front and rear retaining frames, and wherein the front retaining frame and the rear retaining frame, having the front drive-train component part assembly and the rear drive-train component part assembly retained thereby in a hung-down state, are transported to a desired position along the transport path via the frame positioning member.

3. A vehicle assembly method comprising the steps of:
causing a front retaining frame, transported along a first sub transport path, to retain a front drive-train component part assembly having a front suspension combined with an engine in advance;
causing a rear retaining frame, transported along a second sub transport path, to retain a rear drive-train component part assembly having a rear suspension combined with a rear wheel axle in advance;
coupling together the front retaining frame and the rear retaining frame, having the front drive-train component part assembly and the rear drive-train component part assembly retained thereby, by introducing the front and rear retaining frames onto a main transport path;
transferring the front drive-train component part assembly and the rear drive-train component part assembly from the front retaining frame and the rear retaining frame to front and rear receiving members, respectively,
causing the front receiving member and the rear receiving member, having the front drive-train component part assembly and the rear drive-train component part assembly received thereby, to face a vehicle body; and
mounting the front drive-train component part assembly and the rear drive-train component part assembly to the vehicle body.

4. The vehicle assembly method according to claim 3, wherein the first and second sub transport paths and the main transport path are each an elevated transport path, and the front and rear drive-train component part assemblies are retained by the front and rear retaining frames, respectively, in a hung-down state from the front and rear retaining frames, and wherein the front retaining frame and the rear retaining frame, having the front drive-train component part assembly and the rear drive- train component part assembly retained thereby in a hung-down state, are transported to a desired position along the main transport path.

5. The vehicle assembly method of claim 3, further comprising the step of connecting a propeller shaft to the front drive-train component part assembly and the rear drive-train component part assembly after the step of coupling together the front retaining frame and the rear retaining frame.
